(19) United States
(12) Patent Application Publication
(10) Pub. No.: US 2002/0194332 A1
(43) Pub. Date: Dec. 19, 2002

(54) Method and apparatus to manage resources for a multi-threaded device driver

(76) Inventor: Patrick L. Connor, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/881,302

(22) Filed: Jun. 13, 2001

(51) Int. Cl. G06F 15/173; G06F 15/16

(52) U.S. Cl. 709/225; 709/203

(57) ABSTRACT

A method and apparatus to manage a packet array for a device driver is described.

### BACKGROUND

A device driver is software that allows an Operating System (OS) to utilize a hardware device. The OS interface to the device driver is generally a standard, well documented, suite of Application Program Interfaces (APIs). This model allows hardware vendors to provide device drivers for the OS. The device driver has an intimate knowledge of the hardware's external interface, which may be proprietary or conform to a given standard. This model allows new hardware to be added to a computer system and utilized by the OS without requiring the OS to have intimate knowledge of all possible hardware platforms and accessories that it may ever need to utilize.

One function of a device driver may be to manage resources for a device or application. For example, an application or device may be assigned a certain amount of memory. The device driver may be configured to ensure the memory is used properly, such as allocating buffer sizes, preventing data overwrites, modifying data stored in memory, and so forth. The more efficiently a device driver manages its resources, the more efficient the application or device may operate. This is particularly true with respect to memory management, since memory operations may consume a relatively large number of processing cycles as compared to other operations.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features, and advantages thereof, may best be understood by reference to the following detailed description when read with the accompanying drawings in which:

FIG. 1 is a system suitable for practicing one embodiment of the invention;

FIG. 2 illustrates a multi-processor processing system in accordance with one embodiment of the invention;

FIG. 3 illustrates a packet array constructed in accordance with a conventional NDIS device driver algorithm;

FIG. 4 is a block flow diagram of the programming logic performed by a packet array construction (PAC) module in accordance with one embodiment of the invention;

FIG. 5 illustrates a set of packet arrays in accordance with one embodiment of the invention;

FIG. 6 illustrates a set of packet arrays in accordance with another embodiment of the invention;

FIG. 7 illustrates a timeline of events for comparison with one embodiment of the invention; and

FIG. 8 illustrates a network model suitable for use with one embodiment of the invention.

### DETAILED DESCRIPTION

In the following detailed description, numerous specific details are set forth in order to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention.

Embodiments of the invention include a method and apparatus to perform resource management for a device driver. One embodiment of the invention may operate to reduce processing times for received packets by device drivers for network controllers, such as a network interface card (NIC). This may increase the receive throughput for the NIC. One embodiment of the invention may achieve increased receive throughput by selectively indicating resource conditions and changing indication groupings to avoid additional data copies in low resource conditions. More particularly, this embodiment of the invention selectively builds a packet array to enhance processing by any media layer protocol or OS interface.

It is worthy to note that any reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

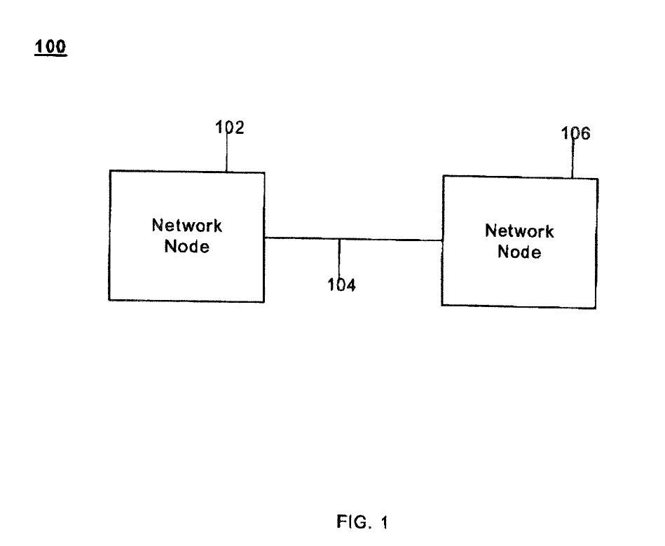

Referring now in detail to the drawings wherein like parts are designated by like reference numerals throughout, there is illustrated in FIG. 1 a system suitable for practicing one embodiment of the invention. FIG. 1 is a block diagram of a network 100 comprising a network node 102 and a network node 106 connected via a communications medium 104. In one embodiment of the invention, a network node may comprise any device comprising the appropriate hardware, software, protocols and connectors to communicate information to another network node over a communications medium. Examples of a network node may comprise a computer, personal computer (PC), server, switch, router, bridge, gateway, network appliance, printer and so forth. Examples of a communications medium may comprise twisted-pair wire, co-axial cable, fiber optics or radio-frequency (RF) spectrum. Although only two network nodes are shown as part of network 100, it can be appreciated that any number of network nodes may be made part of network 100 and still fall within the scope of the invention.

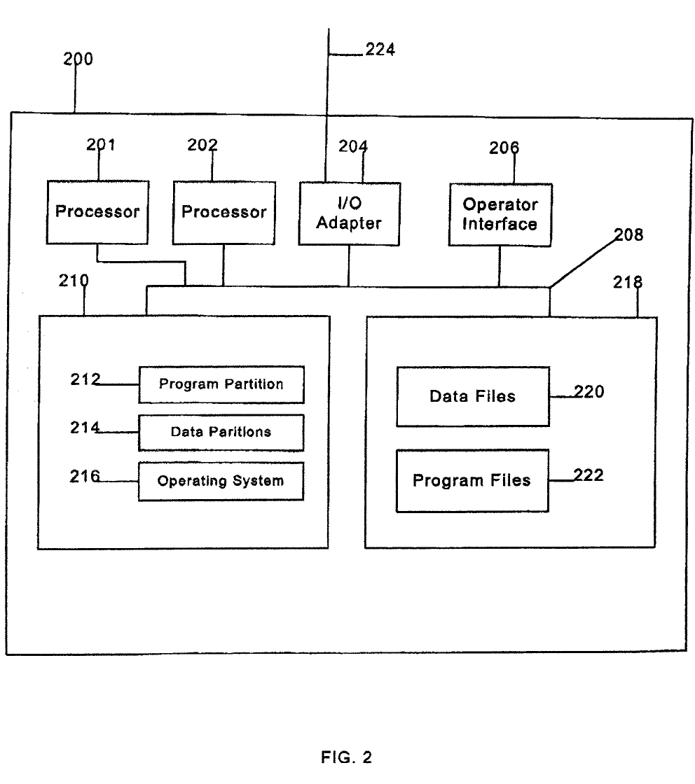

FIG. 2 illustrates a multi-processor processing system in accordance with one embodiment of the invention. In one embodiment of the invention, a processing system 200 may be representative of any of the devices shown as part of network 100. As shown in FIG. 2, system 200 includes a processor 201, a processor 202, an input/output (I/O) adapter 204, an operator interface 206, a memory 210 and a disk storage 218. Memory 210 may store computer program instructions and data. The term “program instructions” may include computer code segments comprising words, values and symbols from a predefined computer language that, when placed in combination according to a predefined manner or syntax, cause a processor to perform a certain function. Examples of a computer language may include C, C++, JAVA, assembly and so forth. Processor 202 executes the program instructions, and processes the data, stored in memory 210. Disk storage 218 stores data to be transferred to and from memory 210. I/O adapter 204 communicates with other devices and transfers data in and out of the computer system over connection 224. Operator interface 206 may interface with a system operator by accepting commands and providing status information. All these elements are interconnected by bus 208, which allows data to be intercommunicated between the elements. I/O adapter 204 represents one or more I/O adapters or network interfaces that can connect to local or wide area networks such as, for example, the network described in FIG. 1. Therefore, connection 224 represents a network or a direct connection to other equipment.

Processors 201 and 202 may be any type of processors capable of providing the speed and functionality required by the embodiments of the invention. For example, processors 201 and 202 could be processors from a family of processors made by Intel Corporation, Motorola Incorporated, Sun Microsystems Incorporated, Compaq Computer Corporation and others. Processors 201 and 202 may also comprise a digital signal processor (DSP) and accompanying architecture, such as a DSP from Texas Instruments Incorporated.

In one embodiment of the invention, memory 210 and disk storage 218 may comprise a machine-readable medium and may include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e., floppy disk and hard drive), optical disk (e.g., CD-ROM) and any other media that may store digital information. In one embodiment of the invention, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, client 200 may contain various combinations of machine-readable storage devices through various I/O controllers, which are accessible by processors 201 and 202 and which are capable of storing a combination of computer program instructions and data.

Memory 210 is accessible by processors 201 and 202 over bus 208 and includes an operating system 216, a program partition 212 and a data partition 214. In one embodiment of the invention, operating system 216 may comprise an operating system sold by Microsoft Corporation, such as Microsoft Windows® 95, 98, 2000 and NT, for example. Program partition 212 stores and allows execution by processors 201 and 202 of program instructions that implement the functions of each respective system described herein. Data partition 214 is accessible by processors 201 and 202 and may store data used during the execution of program instructions.

In one embodiment of the invention, program partition 212 contains program instructions that will be collectively referred to herein as a packet array construction (PAC) module. The PAC module may operate to build and indicate a packet array for a device driver. Of course, the scope of the invention is not limited to this particular set of instructions.

I/O adapter 204 may comprise a network adapter and/or NIC configured to operate with any suitable technique for controlling communication signals between computer or network devices using a desired set of communications protocols, services and operating procedures, for example. In one embodiment of the invention, I/O adapter 204 may operate, for example, in accordance with the Transmission Control Protocol (TCP) as defined by the Internet Engineering Task Force (IETF) standard 7, Request For Comment (RFC) 793, adopted in September, 1981, and the Internet Protocol (IP) as defined by the IETF standard 5, RFC 791, adopted in September, 1981 (collectively referred to herein as “TCP/IP Specification”), both available from “www.ietf.org.” Although 1/O adapter 204 may operate with in accordance with the above described protocols, it can be appreciated that I/O adapter 204 may operate with any suitable technique for controlling communication signals between computer or network devices using a desired set of communications protocols, services and operating procedures, for example, and still fall within the scope of the invention. I/O adapter 204 may also include the appropriate connectors for connecting I/O adapter 204 with a suitable communications medium. I/O adapter 204 may receive communication signals over any suitable medium such as copper leads, twisted-pair wire, co-axial cable, fiber optics, RF spectrum, and so forth.

In one embodiment of the invention, I/O adapter 204 may operate in accordance with a device driver model for network controllers. For example, in one embodiment of the invention I/O adapter 204 is configured to operate in accordance with the Network Driver Interface Specification (NDIS) for Windows based OS, such as Windows NT. NDIS allows for a common interface for network drivers under the Windows OS. This common interface is abstracted from any particular protocol stack or application. Therefore, if a device driver is NDIS compliant, it can interoperate with any Windows protocol or network file system that is also NDIS compliant.

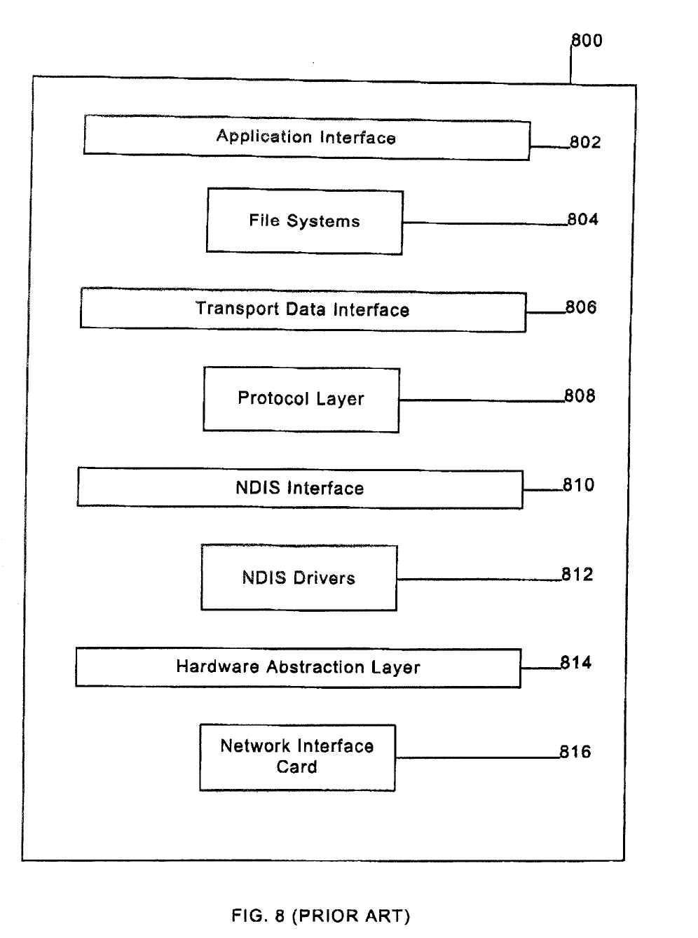

FIG. 8 illustrates a network model suitable for use with one embodiment of the invention. In one embodiment of the invention, I/O adapter 204 may be configured to operate in accordance with the Windows NT network model. An example of this model is shown in FIG. 8. FIG. 8 illustrates a network model 800 comprising an application interface 802, a file system 804, a transport data interface 806, a protocol layer 808, an NDIS interface 810, an NDIS driver 812, a hardware abstraction layer 814 and a NIC 816. The application interface 802 may comprise, for example, a word processor, file manager, web browser, or other application. File system 804 directs file requests to the appropriate system, such as the floppy drive, hard disk, or network. For a network interface the file system 804 may comprise, for example, a WinSock™ file system. Transport Data Interface 806 is a standard Windows interface that allows compliant network file systems to communicate with compliant network protocol layers. Protocol layer 808 may comprise, for example, a protocol operating in accordance with the TCP/IP Specification. The NDIS interface 810 facilitates communication between NDIS compliant protocol drivers and NDIS compliant network controller drivers. NDIS drivers 812 is the layer responsible managing the operation of an I/O controller, such as an Ethernet MAC, Token Ring or ATM controller. An NDIS driver 812 takes standard requests from the NDIS interface 810 and issues commands (which are usually propitiatory) to the NIC 816, via the HAL 814. HAL 814 allows the NDIS driver 812 to access the NIC 816 in a standard and controlled manner.

In Windows NT 4, Microsoft introduced a new API to NDIS. This API allowed NDIS device drivers to indicate an array of received packets to NDIS (and thereby the protocol stack) with a single call. Indicating several packets at once to the protocol stack amortizes the overhead of indication of the packets to the protocol stack over the plurality of packets in the array.

A device driver may utilize the new API to indicate a packet array to a protocol stack for processing. Prior to indicating the packet array, the device driver may be configured to construct the packet array in accordance with desired design parameters. The device driver may receive a packet and determine an explicit resource status for the packet. The explicit resource status may indicate, for example, the amount of resources currently available to the device driver. The resources may comprise, for example, memory available to the device driver to store packets, copy packets and so forth. The device driver may determine a particular resource level and assign an explicit resource status for each packet. The packet may be marked using a flag or status indicator, with the status indicator reflecting any number of desired states. For example, one embodiment of the invention defines two states: a low resource state and a normal resource state. The term “low resource state” may indicate that the explicit resource state is below a predetermined level, while the term “normal resource state” may indicate that the explicit resource state is above or equal to a predetermined level, for example. Once the packet array is full, or if no more packets are received within a certain time period, the device driver may indicate the packet array to a protocol stack or other network interface for further processing. The term “indicate” as used herein may refer to sending a message to the protocol stack or network interface that a packet array is complete and ready for processing. The message may comprise, for example, a memory address or other location information for a first buffer storing the packet array, and the number of elements in the packet array.

The protocol stack receives the packet array indication and begins processing each packet in the array. This processing may include marking each packet with an implicit resource status. In the packet array, if the device driver assigned a low resource state for any packet in the array, this low resource state is implicitly applied to all subsequent packets in the array, regardless of the resource state explicitly indicated by the device driver in the subsequent packets. When a packet indicates a low resource state, this causes the NDIS interface or a protocol in the protocol stack, such as TCP/IP, to copy the packet to a separate buffer before processing it. This allows the device driver to retain control of the buffer and other associated receive resources and prevents the device driver from running completely out of receive resources. However, the drawback is that the data copy from the device driver's buffer to the protocol's buffer increases CPU utilization and can reduce overall throughput.

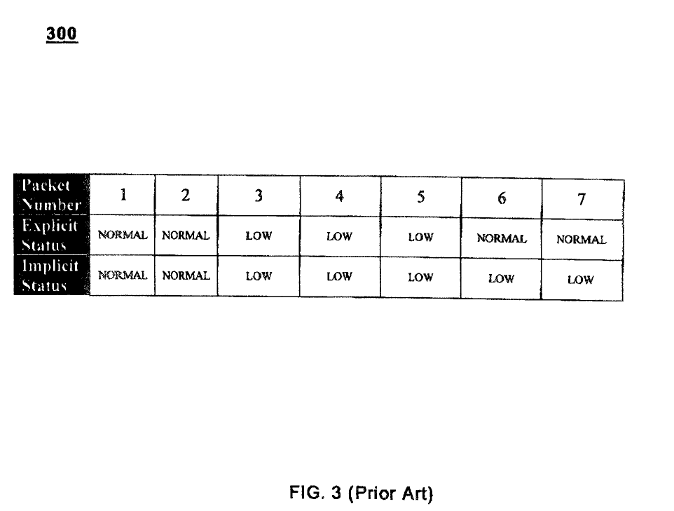

With high-speed networks, such as gigabit or ten-gigabit Ethernet, an end-station, such as a PC or a server, can be overwhelmed with a high rate of incoming data. Flow control protocols attempt to alleviate this but high-speed controllers often find themselves low on resources during these high packet rate burst times. Current methods of indicating packet arrays do not account well for changes in the resource state during the construction of an array of packets. This may be illustrated with reference to FIG. 3.

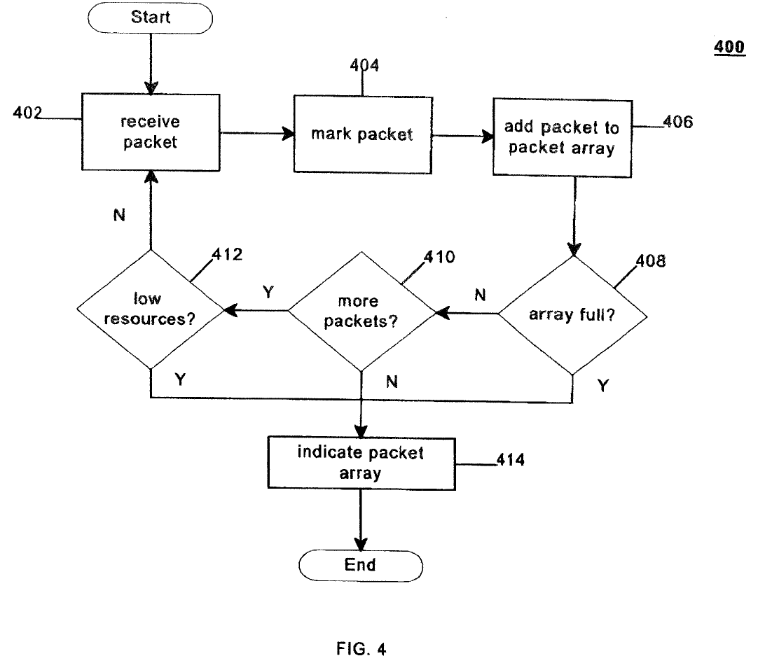

FIG. 3 illustrates a conventional packet array constructed in accordance with a conventional NDIS device driver algorithm. FIG. 4 illustrates a packet array containing 7 packets, with each packet having an explicit resource status indicator and an implicit resource status indicator. As shown in FIG. 3, packets 1 and 2 consumed the last two receive resources, such as receive buffers that were in the ‘normal’ range. Now the available receive resources are below a threshold and considered to be in a low resource state. Packets 3, 4, and 5 are added to the receive array with this explicit low resource status. Before packet 6 is added to the receive array, however, receive resources are returned to the driver (on another processor). This causes the explicit status in packets 6 and 7 to return to a normal state.

In this example, a layer above the driver may copy packets 3-7 before the packets are passed to the protocol stack. Packets 6 and 7, however, explicitly indicate a normal resource state thereby removing the need to copy packets 6-7. The NDIS interface does not heed the explicit status, but rather, the decision to copy is based solely on the implicit status, and therefore packets 6-7 may be unnecessarily copied.

This example uses only seven packets for purposes of clarity. Packet arrays, however, can be arbitrarily long. In high-speed NDIS drivers, such as gigabit Ethernet drivers, they are typically tens or hundreds of packets in length. Each copy increases the latency of processing each packet. Packets being received generally have an associated processing overhead. For example, header checksums must be verified and, presumably, the data is used by some application. Only after this additional processing is done can the associated resources be returned to the device driver or protocol for subsequent packets. Burdening the processor with copies detracts from the amount of time it can spend processing the packets. This only exacerbates the problems that conventional methods have in low resource conditions. When the system has been unable to keep up with the rate of incoming frames, it gets behind at returning receive resources, causing a low resource condition. Then when the system is in a low resource state and system resources are constrained, the system is asked to take on the additional burden of copying incoming packets. This may further delay the processing of packets that have already been received. This in turn may further delay the return of the associated resources, which may be needed to alleviate the low resource condition.

One embodiment of the invention may reduce the need to copy packets between buffers owned by the NDIS Interface and/or a protocol, and the device driver itself. In Windows 2000, Microsoft introduced a feature that allowed NDIS device drivers to be de-serialized or multi-threaded. This allows the driver to be running on multiple processors simultaneously. This means that on one processor the device driver could be indicating received packets, while on another processor NDIS could be returning resources from previously indicated packets that have been processed by the protocol stack. One embodiment of the invention takes advantage of the fact that, on a multiprocessor system the resource state of a de-serialized driver may change while receive indication function is running. In a multiprocessor system, one processor can construct packet arrays and indicate them to the NDIS interface, while on a second processor receive resources can be returned to the driver. One embodiment of the invention may accomplish this by truncating the receive packet array when a low resource state is encountered. This technique may be further explained with reference to FIGS. 4-7.

The operations of systems 100 and 200 may be further described with reference to FIG. 4 and accompanying examples. Although FIG. 4 as presented herein may include a particular processing logic, it can be appreciated that the processing logic merely provides an example of how the general functionality described herein can be implemented. Further, each operation within a given processing logic does not necessarily have to be executed in the order presented unless otherwise indicated.

FIG. 4 is a block flow diagram of the programming logic performed by a PAC module in accordance with one embodiment of the invention. In one embodiment of the invention, the PAC module may refer to the software and/or hardware used to implement the functionality for constructing and indicating a packet array as described herein. In this embodiment of the invention, the PAC module may be implemented as part of network nodes 102 and/or 104, although the embodiments of the invention are not limited to this context.

As shown in FIG. 4, a PAC module when executed by a processor, for example processors 201 and 202, may perform the programming logic described herein. FIG. 4 illustrates a programming logic 400 that may be used to construct a packet array and indicate the packet array to a protocol stack. According to programming logic 400, a packet may be received by a device driver at block 402. A resource state is set for the packet at block 404. The packet may be added to a packet array at block 406.

A determination whether to indicate the packet array to the protocol stack may be based on several factors, such as whether the packet array is full and/or whether any additional packets are waiting for processing by the device driver. One embodiment of the invention may construct and indicate a packet array to the protocol stack based on the resource state of the received packets.

Returning to programming logic 400, a determination as to whether the packet array is full may be made at block 408. If the packet array is full, the packet array is indicated to the protocol stack at block 414. If the packet array is not full, a determination is made as to whether any more packets are waiting to be processed by the device driver at block 410. If there are no more packets waiting at block 410, the packet array is indicated to the protocol stack at block 414. If there are more packets waiting at block 410, processing logic 400 checks the resource state for the packet at block 412. If the resource state is normal, processing logic 400 processes the next received packet at block 402. If the resource state is low, processing logic 400 indicates the packet array to the protocol stack at block 414. The packet array may be stored in a first buffer owned or managed by the device driver as it is being constructed, either by physically copying each packet to the first buffer or constructing a logical packet array using linked lists or pointers.

In one embodiment of the invention, the resource state set for the packet may comprise an explicit resource state. A determination as to the current amount of resources available to the device driver is made. This amount may be compared to a predetermined threshold amount. A resource state indicator for the packet may be set in accordance with the comparison. For example, the resource state indicator may be set to normal if the resource state is above or equal to the predetermined threshold, and the resource state indicator may be set to low if the explicit resource state is below the predetermined threshold.

Once the device driver indicates the packet array to the protocol stack, the protocol stack or the NDIS interface may attempt to return resources to the device driver by copying certain packets from the packet array to the buffers owned by the NDIS interface or the protocol stack. For example, the NDIS interface may receive the packet array, and set an implicit resource state indicator for each packet in the array. This may be performed by retrieving each packet 1-N in order from the packet array, determining the implicit resource state for each packet to be normal if the explicit resource state indicator is normal, and determining the implicit resource state to be low for any remaining packets in the packet array if the explicit resource state indicator is low. The NDIS interface may then copy each packet having an implicit low resource state from a first buffer to a second buffer, where the device driver manages the first buffer and the NDIS interface manages the second buffer.

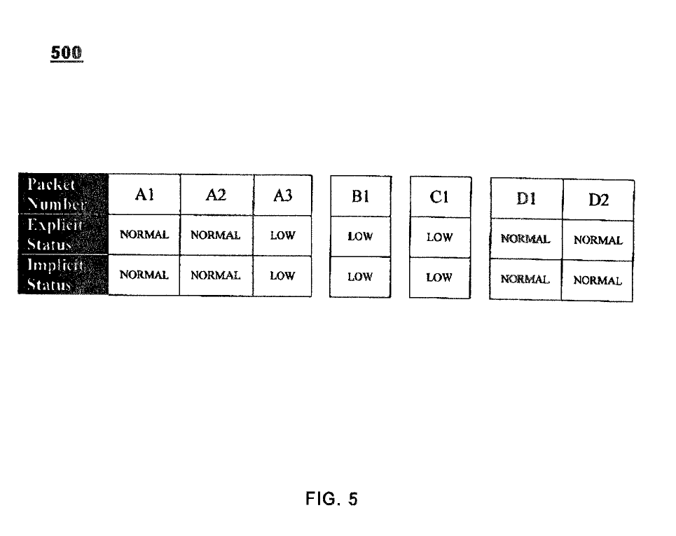

The operation of systems 100 and 200, and the processing logic shown in FIG. 4, may be better understood by way of example. Returning again to the packet pattern example given with reference to FIG. 3, one embodiment of the invention may construct packet arrays for the same seven packets in an improved manner, as shown in FIG. 5.

FIG. 5 illustrates a set of packet arrays in accordance with one embodiment of the invention. Unlike the single packet array constructed by conventional methods as shown in FIG. 3, FIG. 5 illustrates 4 packet arrays for the same packet pattern, with each packet having an explicit resource status indicator and an implicit resource status indicator. The embodiment of the invention constructs four arrays (A, B, C, and D), with array A comprising 3 packets (A1-A3), array B comprising 1 packet (B1), array C comprising 1 packet (C1), and array D comprising 2 packets (D1-D2). As the NDIS interface receives arrays A, B, and C, it copies only the last packet of each array. This results in three packets being copied instead of five packets as with the packet array shown in FIG. 3.

Having more arrays (four in this case) to be indicated is a relatively minor drawback compared to the penalty of additional copies. Adding a packet to a packet array and reclaiming resources from the network OS are also relatively short processes compared to the time to copy a packet. Although copying times may vary according to several factors, such as length of the packet, memory speeds, cache state, and so forth, there is at least a minimum copying time due to a guaranteed cache miss since the packet was Direct Memory Access (DMA) transferred into memory by the I/O controller.

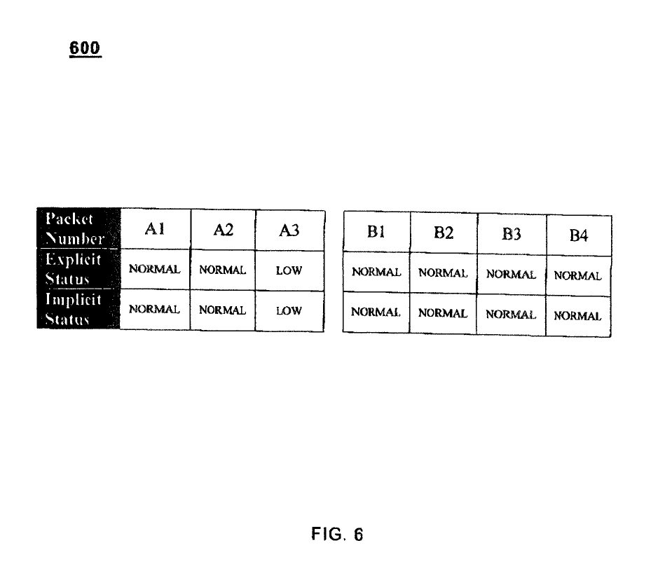

Another embodiment of the invention results in the construction of only two arrays given the same packet pattern given with reference to FIG. 3. When array A is indicated, the protocol stack may be forced to copy packet A3. While this packet is being copied, packets are being returned on another or multiple other processors. With conventional methods, these packets may not be available until packet 6 is being added to the array. In one embodiment of the invention, however, these resources will be available for packet B1. When the invention method truncates array A, it will indicate the array to the NDIS interface. If any of the bound protocols have an interest in packet A3, they must copy the packet so that the receiver resources can be immediately returned to the device driver. In this example, resources from previous packets are being returned on another processor. In this embodiment of the invention, these resources are being returned while packet A3 is being copied. This allows the resources to be available for packet B1. Therefore, the remaining packets can be indicated in a single second array. The resulting packet arrays from this embodiment of the invention are shown in FIG. 6.

FIG. 6 illustrates a set of packet arrays in accordance with another embodiment of the invention. FIG. 6 illustrates 2 packet arrays for a packet pattern that includes 7 packets, with each packet having an explicit resource status indicator and an implicit resource status indicator. This embodiment of the invention results in two arrays (A and B), with array A comprising 3 packets (A1-A3) and array B comprising 4 packets (B1-B4). With this additional timing advantage, for the same packet pattern given with reference to FIG. 3, this embodiment of the invention may result in only one of the seven packets being copied. By way of contrast, conventional methods may result in five of the seven packets being copied.

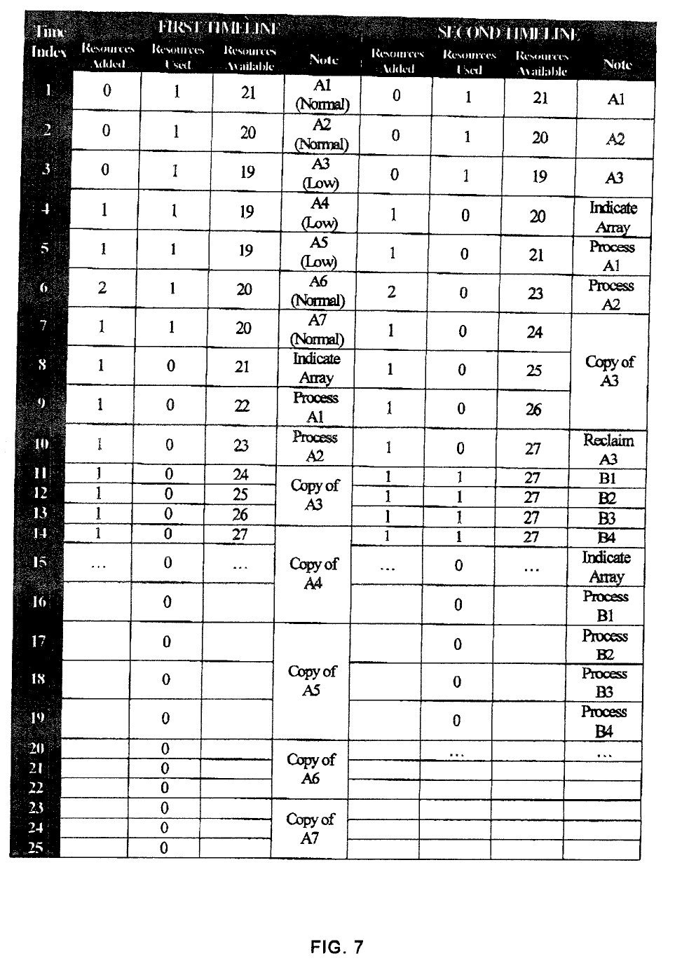

FIG. 7 illustrates a timeline of events for comparison with one embodiment of the invention. To better illustrate how one embodiment of the invention changes the timing of events, below are two time lines for the examples described with reference to FIGS. 3 and 6. In this example, assume the device driver uses 20 as it “Low Resource” threshold. FIG. 7 illustrates how one embodiment of the invention may construct the second array without encountering the low resource condition. It is worthy to note that this embodiment of the invention completes sooner than conventional methods (time index 19 vs. 25).

In these examples, the rate at which resources are being returned is unchanged by the indication algorithm being used since this is being executed on another processor. Despite this, the number of resources available to this embodiment of the invention is better at key times than conventional methods. In fact, at time index 10, this embodiment of the invention would actually have two resources returned to it instead of just one. This is because the resources of packet A3 would be reclaimed on the indicating processor. This detail is not show in FIG. 7, however, to better illustrate the advantage of this embodiment of the invention with a fixed packet return rate.

An additional factor may affect the rate of returned resources. As stated previously, copies detract from the systems ability to process packets and return resources when they may be needed the most. Since one embodiment of the invention may reduce the amount of copies that the system is forced to conduct, it allows more of the available system bandwidth to be used to process the packet data already received. This may allow the associated resources to be returned sooner. This may then allow the system to get out of the low resource condition and return to normal operation sooner as compared to conventional techniques.

Because this invention method only allows one packet in an array to be marked as low resource, the device driver can also reduce its low resource threshold to only one packet's worth. This allows more receive resources to be used in normal operations and may prevent the system from entering low resource operation in the first place.

It is important that the low resource threshold value allow at least one packet to be copied so that the device driver will never be completely out receive resources (for longer than the indicate and copy time). This ensures that the system does not completely lose connectivity on the network.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method to manage a packet array, comprising:
receiving a packet by a device driver;
setting a resource state for said packet;
adding said packet to a packet array; and
indicating said packet array to a protocol stack based on said resource state.

2. The method of claim 1, wherein said setting comprises:
determining a resource state for said device driver;
comparing said resource state to a predetermined threshold; and
setting a resource state indicator in accordance with said comparison.

3. The method of claim 2, wherein said setting said resource state indicator in accordance with said comparison comprises:
setting said resource state indicator to normal if said resource state is above or equal to said predetermined threshold; and
setting said resource state indicator to low if said resource state is below said predetermined threshold.

4. The method of claim 3, wherein said indicating comprises indicating said packet array to said protocol stack if said resource state indicator is set to low.

5. The method of claim 1, wherein said packet array has a length of 1-N.

6. The method of claim 1, wherein said packet array is stored in a first buffer.

7. The method of claim 1, wherein said resource state indicator is an explicit resource state indicator.

8. The method of claim 7, further comprising:
receiving said packet array;
determining an implicit resource state for each packet in said packet array; and
copying each packet having an implicit resource state below a predetermined threshold from said first buffer to a second buffer.

9. The method of claim 8, wherein said packets are ordered from 1-N in said packet array, and determining said implicit resource state comprises:
retrieving each packet in order from said packet array;
determining that said implicit resource state is normal for each packet if said explicit resource state indicator is normal; and
determining that said implicit resource state is low for any remaining packets in said packet array if said explicit resource state indicator is low.

10. An article comprising:
a storage medium;
said storage medium including stored instructions that, when executed by a processor, result in managing a packet array by receiving a packet by a device driver, setting a resource state for said packet, adding said packet to a packet array, and indicating said packet array to a protocol stack based on said resource state.

11. The article of claim 10, wherein the stored instructions, when executed by a processor, further result in setting said resource state for said packet by determining a resource state for said device driver, comparing said resource state to a predetermined threshold, and setting a resource state indicator in accordance with said comparison.

12. The article of claim 11, wherein the stored instructions, when executed by a processor, further result in setting said resource state indicator in accordance with said comparison by setting said resource state indicator to normal if said resource state is above or equal to said predetermined threshold, and setting said resource state indicator to low if said resource state is below said predetermined threshold.

13. The article of claim 12, wherein the stored instructions, when executed by a processor, further result in indicating said packet array to said protocol stack if said resource state indicator is set to low.

14. The article of claim 10, wherein the stored instructions, when executed by a processor, further result in said packet array having a length of 1-N.

15. The article of claim 10, wherein the stored instructions, when executed by a processor, further result in storing said packet array in a first buffer.

16. The article of claim 10, wherein the stored instructions, when executed by a processor, further result in said resource state indicator being an explicit resource state indicator.

17. The article of claim 16, wherein the stored instructions, when executed by a processor, further result in receiving said packet array, determining an implicit resource state for each packet in said packet array, and copying each packet having an implicit resource state below a predetermined threshold from said first buffer to a second buffer.

18. A device driver for a network operating system, comprising:
a packet array construction module to construct a packet array based on an explicit resource status for at least one packet, and to store said packet array in a first buffer; and
a protocol interface to determine an implicit resource status for each packet in said packet array based on said explicit resource status of at least one packet, and to copy each packet from said first buffer to a second buffer based on said implicit resource status.

19. The device driver of claim 18, wherein said packet array construction module truncates said packet array if said explicit resource status for a packet is set to low.
